(19) United States
(12) Patent Application Publication
(10) Pub. No.: US 2012/0213759 A1
(43) Pub. Date: Aug. 23, 2012

(54) ANTIMICROBIAL CLEANING AGENT FOR HARD SURFACES

(75) Inventors: Stefan Karsten, Gummersbach (DE); Maike Janssen, Dusseldorf (DE); Kaoru Tachikawa, Dortmund (DE)

(73) Assignee: Henkel AG & Co., KGaA, Dusseldorf (DE)

(21) Appl. No.: 13/459,674

(22) Filed: Apr. 30, 2012

Related U.S. Application Data
(63) Continuation of application No. PCT/EP2010/065948, filed on Oct. 22, 2010.

(30) Foreign Application Priority Data
Oct. 30, 2009 (DE) 10 2009 046 215.5

(51) Int. Cl. A01N 33/12; A01P 1/00; A01N 63/02

(52) U.S. Cl. 424/94.1; 514/643

(57) ABSTRACT

A surfactant-containing aqueous antimicrobially effective cleaning agent for hard surfaces includes at least one amphoteric polymer, a quaternary ammonium compound and formic acid. The agent may be used for the cleaning and/or antimicrobial treatment of hard surfaces, in particular in damp rooms such as bathrooms.

### CROSS-REFERENCES TO RELATED APPLICATIONS

This application is a continuation of PCT/EP2010/065948, filed on Oct. 22, 2010, which claims priority under 35 U.S.C. §119 to DE 10 2009 046 215.5 filed on Oct. 30, 2009, both of which are hereby incorporated by reference.

### FIELD OF THE INVENTION

The present invention generally relates to a surfactant-containing aqueous antimicrobially effective cleaning agent for hard surfaces, encompassing at least one acrylic copolymer, a quaternary ammonium compound and formic acid. The agent is suitable for the cleaning and/or antimicrobial treatment of hard surfaces, in particular in damp rooms such as bathrooms.

### BACKGROUND OF THE INVENTION

Above all in damp or damp and warm rooms, in which bacteria and molds find ideal conditions for growth, the antimicrobial treatment of hard surfaces in addition to simple cleaning is expedient and desirable. Molds in particular, and most of all Aspergillus niger, have proved to be stubborn and are known to be harmful to health.

An improvement of the cleaning performance and/or a reduction of the tendency for soiling, in particular soap scum, to build up again would be desirable, in order to deny germs their breeding ground and hence to lessen the bacterial contamination of surfaces.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

It has now been found that a surfactant-containing aqueous agent, containing at least one acrylic copolymer, a quaternary ammonium compound and formic acid, has a high antimicrobial effectiveness against germs such as Staphylococcus aureus, Enterococcus hirae, Pseudomonas aeruginosa, Escherichia coli, Candida albicans and Aspergillus niger, while also demonstrating an outstanding cleaning performance.

This application therefore provides a surfactant-containing aqueous antimicrobially effective cleaning agent for hard surfaces, encompassing at least one amphoteric polymer, a quaternary ammonium compound and formic acid.

The agent is suitable in particular for the cleaning and/or antimicrobial treatment of hard surfaces, above all in damp rooms, for instance in bathrooms.

This application therefore also provides the use of a cleaning agent according to the invention for the cleaning and/or antimicrobial treatment of hard surfaces, in particular in damp rooms such as bathrooms.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Within the context of the present invention, unless otherwise specified, the terms fatty acids and fatty alcohols or derivatives thereof are used to represent branched or unbranched carboxylic acids and alcohols or derivatives thereof having preferably 6 to 22 carbon atoms. As plant-based substances based on sustainable raw materials, the first group in particular is preferred on ecological grounds, without however restricting the teaching according to the invention thereto. In particular, the oxo alcohols and derivatives thereof obtainable for example by Roelen oxo synthesis can be used accordingly.

Whenever mention is made below of alkaline-earth metals as counterions for monovalent anions, it means that the alkaline-earth metal is naturally only used in half the amount of the anion (sufficient for charge compensation).

Substances that also serve as ingredients of cosmetic agents are where applicable referred to below by their International Nomenclature of Cosmetic Ingredients (INCI) name. Chemical compounds have an INCI name in English, plant ingredients are listed exclusively in Latin using Linnaean classification, and trivial names such as “water”, “honey” or “sea salt” are likewise given in Latin. The INCI names can be found in the International Cosmetic Ingredient Dictionary and Handbook, Seventh Edition (1997), which is published by The Cosmetic, Toiletry, and Fragrance Association (CTFA), 1101 17th Street, NR, Suite 300, Washington, D.C. 20036, USA, and contains more than 9000 INCI names and references to over 37,000 trade names and technical names, including associated distributors from more than 31 countries. The International Cosmetic Ingredient Dictionary and Handbook assigns one or more chemical classes, for example Polymeric Ethers, and one or more functions, for example Surfactants—Cleansing Agents, to the ingredients, which classes and functions it also describes in more detail and to which where applicable reference is likewise made below. The reference CAS means that the sequence of numbers that follows it is a designation by the Chemical Abstracts Service.

### Amphoteric Polymer

The agent according to the invention contains an amphoteric polymer. Suitable examples having hydrophilizing properties are for example copolymers of acrylic or methacrylic acid and MAPTAC (methacryloyl aminopropyl trimethyl ammonium chloride, 3-trimethylammonium propyl methacrylamide chloride), DADMAC (diallyldimethyl ammonium chloride) or another polymerizable quaternary ammonium compound. Copolymers with AMPS (2-acrylamido-2-methylpropanesulfonic acid) can moreover also be used. Polyether siloxanes, in other words copolymers of polymethyl siloxanes having ethylene oxide or propylene oxide segments, are further suitable polymers. Acrylic polymers, maleic acid copolymers and polyurethanes having PEG (polyethylene glycol) units can likewise be used.

Suitable polymers are available commercially for example under the trade names Mirapol Surf-S 100, 110, 200, 210, 400, 410, A 300, A 400 (Rhodia), Tegopren 5843 (Goldschmidt), Sokalan CP 9 (BASF) or Polyquart Ampho 149 (Cognis).

The agent according to the invention contains the amphoteric polymer preferably in an amount from 0.01 to 1.0 wt. %, preferably 0.05 to 0.5 wt. %.

### Quaternary Ammonium Compound

The agent according to the invention also contains a quaternary ammonium compound, which contributes to the antimicrobial effectiveness of the agent. Cationic surfactants of the formula (Rⁱ)(Rⁱⁱ)(Rⁱⁱⁱ)(R^{iv})N⁺X⁻ are suitable for example, in which Rⁱ to R^{iv} denote identical or different, in particular two long-chain and two short-chain, alkyl residues, and X⁻ denotes an anion, in particular a halide ion, for example didecyldimethylammonium chloride, alkylbenzyldidecylammonium chloride and mixtures thereof. Particularly suitable, however, are quaternary ammonium compounds of the stated formula, in which Rⁱ and Rⁱⁱ denote two identical or different short-chain alkyl resides, preferably methyl groups, Rⁱⁱⁱ denotes a longer-chain alkyl residue, R^{iv} denotes an aromatic residue and X⁻ denotes an anion, in particular a halide ion. Benzalkonium chloride is particularly preferably used.

The agent according to the invention preferably contains the quaternary ammonium compound, preferably benzalkonium chloride, in an amount from 0.05 to 10 wt. %, preferably 0.1 to 2.0 wt. %.

### Formic Acid

The cleaning agent according to the invention additionally contains formic acid (methanoic acid), the simplest aliphatic monocarboxylic acid. Formic acid is preferably included in an amount from 1.8 to 5 wt. %.

### Surfactants

The agent according to the invention also contains surface-active substances. Surfactants, in particular from the classes of anionic and non-ionic surfactants, are suitable as surface-active substances for the agents according to the invention. The agents preferably contain at least one non-ionic surfactant, particularly preferably a non-ionic surfactant based on fatty chemicals, most particularly preferably a sugar surfactant, in particular alkyl polyglycoside (APG).

Alkyl polyglycosides are surfactants which can be obtained by reacting sugars and alcohols by the appropriate methods of preparative organic chemistry, resulting in a mixture of monoalkylated, oligomeric or polymeric sugars, depending on the type of production. Preferred alkyl polyglycosides are the alkyl polyglucosides, wherein the alcohol is particularly preferably a long-chain fatty alcohol or a mixture of long-chain fatty alcohols having branched or unbranched C₈ to C₁₈ alkyl chains, and the degree of oligomerization (DP) of the sugars is between 1 and 10, preferably 1 to 6, in particular 1.1 to 3, most preferably 1.1 to 1.7, for example C₈₋₁₀ alkyl-1.5-glucoside (DP of 1.5).

The agent according to the invention preferably contains at least one alkyl polyglycoside in an amount from 0.5 to 5 wt. %, preferably 1 to 3 wt. %.

Further non-ionic surfactants within the context of the invention can be alkoxylates, such as polyglycol ethers, fatty alcohol polyglycol ethers (fatty alcohol alkoxylates), alkylphenol polyglycol ethers, end-capped polyglycol ethers, mixed ethers and hydroxy mixed ethers and fatty acid polyglycol esters. Ethylene oxide, propylene oxide, block polymers and fatty acid alkanolamides and fatty acid polyglycol ethers can likewise be used. Other sugar surfactants (polyol surfactants), for instance fatty acid glucamides, can also be used.

Preferred fatty alcohol polyglycol ethers are unbranched or branched, saturated or unsaturated C₈₋₂₂ alcohols alkoxylated with ethylene oxide (EO) and/or propylene oxide (PO) and having a degree of alkoxylation of up to 30, preferably ethoxylated C₁₀₋₁₈ fatty alcohols having a degree of ethoxylation of less than 30, preferably 1 to 20, in particular 1 to 12, particularly preferably 1 to 8, for example C₁₂₋₁₄ fatty alcohol ethoxylates having 8 EO.

Anionic surfactants according to the invention can be aliphatic sulfates such as fatty alcohol sulfates, fatty alcohol ether sulfates, dialkyl ether sulfates, monoglyceride sulfates and aliphatic sulfonates such as alkane sulfonates, olefin sulfonates, ether sulfonates, n-alkyl ether sulfonates, ester sulfonates and lignin sulfonates. Likewise suitable for use within the context of the present invention are alkylbenzene sulfonates, fatty acid cyanamides, sulfosuccinates (sulfosuccinic acid esters), sulfosuccinamates, sulfosuccinamides, fatty acid isethionates, acyl aminoalkane sulfonates (fatty acid taurides), fatty acid sarcosinates, ether carboxylic acids and alkyl (ether) phosphates as well as a-sulfo fatty acid salts, acyl glutamates, monoglyceride disulfates and alkyl ethers of glycerol disulfate.

Fatty alcohol sulfates and/or fatty alcohol ether sulfates, in particular fatty alcohol sulfates, are preferred within the context of the present invention. Fatty alcohol sulfates are products of sulfation reactions with corresponding alcohols, while fatty alcohol ether sulfates are products of sulfation reactions with alkoxylated alcohols. The person skilled in the art understands alkoxylated alcohols in general to be reaction products of alkylene oxide, preferably ethylene oxide, with alcohols, within the meaning of the present invention preferably with longer-chain alcohols. Depending on the reaction conditions, n moles of ethylene oxide and one mole of alcohol generally give rise to a complex mixture of addition products of varying degrees of ethoxylation. A further embodiment of alkoxylation consists in the use of mixtures of alkylene oxides, preferably of the mixture of ethylene oxide and propylene oxide. Preferred fatty alcohol ether sulfates are the sulfates of low-ethoxylated fatty alcohols having 1 to 4 ethylene oxide units (EO), in particular 1 to 2 EO, for example 1.3 EO.

The anionic surfactants are conventionally used as salts, but also as acids. The salts are preferably alkali metal salts, alkaline-earth metal salts, ammonium salts and mono-, di and trialkanolammonium salts, for example mono-, di- and triethanolammonium salts, in particular lithium, sodium, potassium or ammonium salts, particularly preferably sodium or potassium salts, most preferably sodium salts.

The agent according to the invention can moreover contain amphoteric surfactants. The amphoteric surfactants (zwitterionic surfactants) that can be used according to the invention include betaines, amine oxides, alkyl amido alkyl amines, alkyl-substituted amino acids, acylated amino acids and biosurfactants, of which within the context of the teaching according to the invention betaines are particularly preferred.

Suitable betaines are alkyl betaines, alkyl amido betaines, imidazolinium betaines, sulfobetaines (INCI Sultaines) and amidosulfobetaines as well as phosphobetaines. The suitable amine oxides according to the invention include alkyl amine oxides, in particular alkyl dimethyl amine oxides, alkyl amidoamine oxides and alkoxyalkyl amine oxides.

### Further Conventional Ingredients

The agent according to the invention can additionally contain further conventional ingredients of cleaning agents, for example further surfactants, acids, bases, solvents, disinfectants, pH adjusters, scents and dyes, buffers, viscosity regulators, corrosion inhibitors, complexing agents, film formers, further antimicrobial active ingredients, builders, bleaching agents, enzymes, organic and inorganic salts, optical brighteners, antioxidants, opacifiers, hydrotropes, abrasives, preservatives, oxidizing agents or insecticides and mixtures thereof.

### Acids

In addition to formic acid, the agent according to the invention can contain one or more further acids. Organic and/or inorganic acids can be used here. Examples of organic acids that can be used are lactic acid, citric acid, acetic acid, glycolic acid, succinic acid, adipic acid, malic acid, tartaric acid and gluconic acid, while phosphoric acid, hydrochloric acid, nitric acid, sulfuric acid or sulfamic acid for example can be used as inorganic acids. Lactic acid (2-hydroxypropionic acid) and citric acid (2-hydroxy-1,2,3-propanetricarboxylic acid) are preferred, in particular lactic acid. The acid is preferably included in an amount from 0.1 to 3.0 wt. %, particularly preferably 0.5 to 2.0 wt. %.

### Volatile Alkali; Bases

The agents according to the invention can moreover contain volatile alkali. Ammonia and/or alkanolamines, which can contain up to 9 C atoms in the molecule, are used as such. Ethanolamines are preferred as alkanolamines, and of those in turn monoethanolamine. The content of ammonia and/or alkanolamine is preferably no greater than 2 wt. %; ammonia is particularly preferably used.

The cleaning agents according to the invention can additionally also contain small amounts of bases. Preferred bases derive from the group of alkali and alkaline-earth metal hydroxides and carbonates, in particular alkali metal hydroxides, of which potassium hydroxide and above all sodium hydroxide are particularly preferred.

The addition of alkaline substances also serves here to establish the desired pH. In the agent according to the invention this is in the acid range, preferably between 1 and 5, particularly preferably between 2 and 4, in particular 3.

### Solvents

As a further component the cleaning agent according to the invention can contain one or more water-soluble or water-miscible organic solvents. Suitable solvents are for example saturated or unsaturated, preferably saturated, branched or unbranched C₁₋₂₀ hydrocarbons, preferably C₂₋₁₅ hydrocarbons, having at least one hydroxyl group and optionally one or more C—O—C ether functions, i.e. oxygen atoms interrupting the carbon atom chain. Preferred solvents are the C₂₋₆ alkylene glycols and poly-C₂₋₃ alkylene glycol ethers, optionally etherified on one side with a C₁₋₆ alkanol and having on average 1 to 9 identical or different, preferably identical, alkylene glycol groups per molecule, and also C₁₋₆ alcohols, preferably ethanol, n-propanol or isopropanol, in particular ethanol. However, solvents containing aromatic groups can also be used in an appropriate manner in the agent according to the invention, for instance ethylene glycol monophenyl ethers (monophenyl glycol, phenoxyethanol).

Examples of solvents are the following compounds identified by their INCI names: Alcohol (Ethanol), Buteth-3, Butoxydiglycol, Butoxyethanol, Butoxyisopropanol, Butoxypropanol, n-Butyl Alcohol, t-Butyl Alcohol, Butylene Glycol, Butyloctanol, Diethylene Glycol, Dimethoxydiglycol, Dimethyl Ether, Dipropylene Glycol, Ethoxydiglycol, Ethoxyethanol, Ethyl Hexanediol, Glycol, Hexanediol, 1,2,6-Hexanetriol, Hexyl Alcohol, Hexylene Glycol, Isobutoxypropanol, Isopentyldiol, Isopropyl Alcohol (iso-Propanol), 3-Methoxybutanol, Methoxydiglycol, Methoxyethanol, Methoxyisopropanol, Methoxymethylbutanol, Methoxy PEG-10, Methylal, Methyl Alcohol, Methyl Hexyl Ether, Methylpropanediol, Neopentyl Glycol, PEG-4, PEG-6, PEG-7, PEG-8, PEG-9, PEG-6 Methyl Ether, Pentylene Glycol, Phenoxyethanol, PPG-7, PPG-2-Buteth-3, PPG-2 Butyl Ether, PPG-3 Butyl Ether, PPG-2 Methyl Ether, PPG-3 Methyl Ether, PPG-2 Propyl Ether, Propanediol, Propyl Alcohol (n-Propanol), Propylene Glycol, Propylene Glycol Butyl Ether, Propylene Glycol Propyl Ether, Tetrahydrofurfuryl Alcohol, Trimethylhexanol.

The agent according to the invention contains water-soluble or water-miscible organic solvents preferably in amounts of up to 15 wt. %, particularly preferably 0.1 to 10 wt. %, in particular 0.5 to 5 wt. %.

### Complexing Agents

Complexing agents (INCI Chelating Agents), also known as sequestering agents, are ingredients that are capable of complexing and inactivating metal ions in order to prevent their disadvantageous effects on the stability or the appearance of the agents, for example cloudiness. Firstly it is important to complex the calcium and magnesium ions associated with water hardness, which are incompatible with many ingredients. Secondly, complexing the ions of heavy metals such as iron or copper delays the oxidative decomposition of the finished agents. The complexing agents additionally support the cleaning action. In a preferred embodiment the agent according to the invention therefore contains one or more complexing agents.

The following complexing agents, identified where possible by their INCI name, are suitable for example: Aminotrimethylene phosphonic acid, Beta-Alanine Diacetic Acid, Calcium Disodium EDTA, Citric Acid, Cyclodextrin, Cyclohexanediamine Tetraacetic Acid, Diammonium Citrate, Diammonium EDTA, Diethylenetriamine Pentamethylene Phosphonic Acid, Dipotassium EDTA, Disodium Azacycloheptane Diphosphonate, Disodium EDTA, Disodium Pyrophosphate, EDTA, Etidronic Acid (HEDP, Hydroxyethylidene diphosphonic acid), Galactaric Acid, Gluconic Acid, Glucuronic Acid, HEDTA, Hydroxypropyl Cyclodextrin, Methyl Cyclodextrin, Pentapotassium Triphosphate, Methyl glycine diacetic acid (MGDA), Pentasodium Aminotrimethylene Phosphonate, Pentasodium Ethylenediamine Tetramethylene Phosphonate, Pentasodium Pentetate, Pentasodium Triphosphate, Pentetic Acid, Phytic Acid, Polyamine, Potassium Citrate, Potassium EDTMP, Potassium Gluconate, Potassium Polyphosphate, Potassium Trisphosphonomethylamine Oxide, Ribonic Acid, Sodium Chitosan Methylene Phosphonate, Sodium Citrate, Sodium Diethylenetriamine Pentamethylene Phosphonate, Sodium Dihydroxyethylglycinate, Sodium EDTMP, Sodium Gluceptate, Sodium Gluconate, Sodium Glycereth-1 Polyphosphate, Sodium Hexametaphosphate, Sodium Metaphosphate, Sodium Metasilicate, Sodium Phytate, Sodium Polydimethylglycinophenolsulfonate, Sodium Trimetaphosphate, TEA-EDTA, TEA-Polyphosphate, Tetrahydroxyethyl Ethylenediamine, Tetrahydroxypropyl Ethylenediamine, Tetrapotassium Etidronate, Tetrapotassium Pyrophosphate, Tetrasodium EDTA, Tetrasodium Etidronate, Tetrasodium Pyrophosphate, Tripotassium EDTA, Trisodium Dicarboxymethyl Alaninate, Trisodium EDTA, Trisodium HEDTA, Trisodium MGDA, Trisodium NTA and Trisodium Phosphate. Complexing agents are preferably used in amounts of up to 5 wt. %, particularly preferably 0.1 to 2 wt. %.

### Viscosity Regulators

The agent according to the invention can moreover contain viscosity regulators. Suitable viscosity regulators are for example organic natural thickening agents (agar-agar, carrageen, xanthan, tragacanth, gum arabic, alginates, pectins, polyoses, guar meal, carob seed meal, starch, dextrins, gelatin, casein), organic modified natural substances (carboxymethyl cellulose and other cellulose ethers, hydroxyethyl and hydroxypropyl cellulose and the like, seed meal ethers), organic fully synthetic thickening agents (polyacrylic and polymethacrylic compounds, vinyl polymers, polycarboxylic acids, polyethers, polyimines, polyamides) and inorganic thickening agents (polysilicas, clay minerals such as montmorillonites, zeolites, silicas).

### Further Disinfectants and Preservatives

The cleaning agent according to the invention can contain one or more further antimicrobial active ingredients, preferably in an amount of up to 1 wt. %.

Within the context of the teaching according to the invention the terms disinfection, sanitation, antimicrobial effect and antimicrobial active ingredient have the customary technical meaning, as described for example by K. H Wallhäuβer in “Praxis der Sterilisation, Desinfektion—Konservierung: Keimidentifizierung—Betriebshygiene” (5^{th} edition—Stuttgart; New York: Thieme, 1995). Whereas disinfection in the narrower sense of medical practice denotes the killing of—theoretically all—infectious germs, sanitation is understood to mean the elimination as far as possible of all germs, even saprophytic germs which are normally harmless to humans. The extent of the disinfection or sanitation is dependent on the antimicrobial effect of the agent used, which decreases in line with the decreasing content of antimicrobial active ingredient or with the increasing dilution of the agent for application.

Suitable according to the invention are for example antimicrobial active ingredients from the groups of alcohols, aldehydes, antimicrobial acids or salts thereof, carboxylic acid esters, acid amides, phenols, phenol derivatives, diphenyls, diphenyl alkanes, urea derivatives, oxygen and nitrogen acetals and formals, benzamidines, isothiazoles and derivatives thereof such as isothiazolines and isothiazolinones, phthalimide derivatives, pyridine derivatives, antimicrobial surface-active compounds, guanidines, antimicrobial amphoteric compounds, quinolines, 1,2-dibromo-2,4-dicyanobutane, iodo-2-propynyl butyl carbamate, iodine, iodophors and peroxides. Preferred antimicrobial active ingredients are preferably selected from the group encompassing ethanol, n-propanol, i-propanol, 1,3-butanediol, phenoxyethanol, 1,2-propylene glycol, glycerol, undecenoic acid, citric acid, lactic acid, benzoic acid, salicylic acid, thymol, 2-benzyl-4-chlorophenol, 2,2′-methylene bis-(6-bromo-4-chlorophenol), 2,4,4′-trichloro-2′-hydroxydiphenyl ether, N-(4-chlorophenyl)-N-(3,4-dichlorophenyl)urea, N,N′-(1,10-decanediyl di-1-pyridinyl-4-ylidene) bis-(1-octanamine) dihydrochloride, N,N-bis-(4-chlorophenyl)-3,12-diimino-2,4,11,13-tetraazatetradecane diimidamide, antimicrobial quaternary surface-active compounds, guanidines. Preferred antimicrobially effective surface-active quaternary compounds contain an ammonium, sulfonium, phosphonium, iodonium or arsonium group, such as are described for example by K. H. Wallhäuβer in “Praxis der Sterilisation, Desinfektion—Konservierung: Keimidentifizierung—Betriebshygiene” (5^{th} edition—Stuttgart; New York: Thieme, 1995).

### Dyes and Scents

The agent can contain one or more scent, preferably in an amount from 0.01 to 1 wt. %, in particular 0.02 to 0.8 wt. %, particularly preferably 0.05 to 0.5 wt. %, most preferably 0.1 to 0.3 wt. %, and/or one or more dyes (INCI Colorants), preferably in an amount from 0.0001 to 0.1 wt. %, in particular 0.0005 to 0.05 wt. %, particularly preferably 0.001 to 0.01 wt. %.

### Corrosion Inhibitors

The agent can moreover contain one or more corrosion inhibitors, preferably in an amount from 0.01 to 10 wt. %, in particular 0.1 to 5 wt. %, particularly preferably 0.5 to 3 wt. %, most preferably 1 to 2 wt. %.

Suitable corrosion inhibitors (INCI Corrosion Inhibitors) are for example the following substances identified by their INCI names: Cyclohexylamine, Diammonium Phosphate, Dilithium Oxalate, Dimethylamino Methylpropanol, Dipotassium Oxalate, Dipotassium Phosphate, Disodium Phosphate, Disodium Pyrophosphate, Disodium Tetrapropenyl Succinate, Hexoxyethyl Diethylammonium, Phosphate, Nitromethane, Potassium Silicate, Sodium Aluminate, Sodium Hexametaphosphate, Sodium Metasilicate, Sodium Molybdate, Sodium Nitrite, Sodium Oxalate, Sodium Silicate, Stearamidopropyl Dimethicone, Tetrapotassium Pyrophosphate, Tetrasodium Pyrophosphate, Triisopropanolamine.

### Bleaching Agents

According to the invention bleaching agents can be added to the cleaning agent. Suitable bleaching agents encompass peroxides, per-acids and/or perborates, with H₂O₂ being particularly preferred.

### Enzymes

The agent can also contain enzymes, preferably proteases, lipases, amylases, hydrolases and/or cellulases. They can be added to the agent according to the invention in any form established according to the prior art. In the case of agents in liquid or gel form these include in particular solutions of the enzymes, advantageously as concentrated as possible, with a low water content and/or mixed with stabilizers. Alternatively the enzymes can be encapsulated, for example by spray drying or extrusion of the enzyme solution together with a preferably natural polymer, or in the form of capsules, for example those in which the enzymes are enclosed as in a solidified gel or in those of the core-shell type, in which an enzyme-containing core is coated with a protective layer which is impermeable to water, air and/or chemicals. Further active ingredients, for example stabilizers, emulsifiers, pigments, bleaches or dyes, can additionally be applied in superimposed layers. Such capsules are applied by methods known per se, for example by vibrating or roll granulation or in fluidized-bed processes. Such granules are advantageously low in dust, for example through the application of polymeric film formers, and stable in storage because of the coating.

Enzyme stabilizers can also be present in agents containing enzymes, in order to protect an enzyme contained in an agent according to the invention from damage such as for example inactivation, denaturation or decomposition due to physical influences, oxidation or proteolytic cleavage for instance. The following are suitable in particular as enzyme stabilizers, depending in each case on the enzyme used: benzamidine hydrochloride, borax, boric acids, boronic acids or salts or esters thereof, above all derivatives having aromatic groups, for instance substituted phenyl boronic acids or salts or esters thereof; peptide aldehydes (oligopeptides having a reduced C-terminus), amino alcohols such as mono-, di-, triethanol- and -propanolamine and mixtures thereof, aliphatic carboxylic acids up to C₁₂, such as succinic acid, other dicarboxylic acids or salts of the specified acids; end-capped fatty acid amide alkoxylates; low aliphatic alcohols and above all polyols, for example glycerol, ethylene glycol, propylene glycol or sorbitol; as well as reducing agents and antioxidants such as sodium sulfite and reducing sugars. Further suitable stabilizers are known from the prior art. Combinations of stabilizers are preferably used, for example the combination of polyols, boric acid and/or borax, the combination of boric acid or borate, reducing salts and succinic acid or other dicarboxylic acids, or the combination of boric acid or borate with polyols or polyamino compounds and with reducing salts.

The agents according to the invention are preferably used to clean hard surfaces. The antimicrobial treatment of hard surfaces is also possible with the agent. Hard surfaces within the meaning of this application are windows, mirrors and other glass surfaces, surfaces made from ceramics, plastics, metal or wood and painted wood such as are found at home and in commerce, for instance ceramic sanitary ware, kitchen surfaces or floors. In particular, however, they are surfaces that are occasionally or frequently washed over with dirty or with clean water, for example WCs, showers, bathtubs and floors in bathrooms or also kitchen surfaces, but in particular surfaces such as occur above all in damp rooms such as bathrooms.

The application therefore also provides the use of a cleaning agent according to the invention for the cleaning and/or antimicrobial treatment of hard surfaces, in particular in damp rooms such as bathrooms.

### Embodiment Examples

Cleaning agents according to the invention E1 to E3 were produced and tested with regard to their antimicrobial effectiveness and their soil removing capacity. Comparison formulations C1 to C3 were also produced. The compositions are listed in the table below. All amounts are stated in wt. %, relative to the active substance.

An alkyl polyglycoside (APG 220 UPW, Cognis) was used as the non-ionic surfactant, and the acrylic copolymer used was Mirapol Surf S 110 (Rhodia). The sodium hydroxide was added for pH adjustment in the necessary amount.

| | E1 | E2 | E3 | C1 | C2 | C3 |
|---|---|---|---|---|---|---|
| Non-ionic surfactant | 1.58 | 1.58 | 1.58 | 2.96 | 2.52 | 2.52 |
| Formic acid | 2.55 | 2.55 | 2.55 | 1.70 | 1.70 | 1.70 |
| Lactic acid | 0.96 | 0.96 | 0.96 | 1.60 | 0.96 | 0.96 |
| Sodium hydroxide | + | + | + | + | + | + |
| Acrylic copolymer | 0.05 | 0.05 | 0.05 | — | 0.05 | — |
| Benzalkonium chloride | 0.5 | 0.5 | 0.5 | 0.5 | 0.5 | 0.5 |
| Monophenyl glycol | — | 0.5 | 0.5 | — | — | — |
| Amino tris(methylenephosphonic | — | — | 0.16 | — | — | — |
| acid) | | | | | | |
| Perfume | 0.3 | 0.3 | 0.3 | 0.3 | 0.3 | 0.3 |
| Water | to 100 | to 100 | to 100 | to 100 | to 100 | to 100 |
| pH | 3 | 3 | 3 | 3 | 3 | 3 |

To assess the antimicrobial effectiveness tests were performed in accordance with the European test standards EN 1276, EN 1650 and EN 13679.

While both the formulations according to the invention and the comparison formulations passed the test according to EN 1276, only the agents according to the invention performed convincingly in the other two tests.

The soil removing capacity was also tested. In a standardized test the percentage of dirt removed after 100 wiping actions was visually determined:

| | E1 | E2 | E3 | C1 | C2 | C3 |
|---|---|---|---|---|---|---|
| Soil removal (%) | 50 | 52 | 60-70 | 15 | 30 | 12 |

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A surfactant-containing aqueous antimicrobially effective cleaning agent for hard surfaces, comprising at least one amphoteric polymer, a quaternary ammonium compound and formic acid.

2. The cleaning agent according to claim 1, further comprising at least one alkyl polyglycoside as the surfactant.

3. The cleaning agent according to claim 1, wherein the amphoteric polymer is included in an amount from 0.01 to 1.0 wt. %.

4. The cleaning agent according to claim 1, wherein the quaternary ammonium compound comprises benzalkonium chloride and is included in an amount from 0.05 to 10 wt. %.

5. The cleaning agent according to claim 1, wherein the formic acid is included in an amount from 1.8 to 5 wt. %.

6. The cleaning agent according to claim 2, wherein the at least one alkyl polyglycoside is included in an amount from 0.5 to 5 wt. %.

7. The cleaning agent according to claim 1, further comprising at least one cleaning agent selected from the group consisting of further surfactants, acids, bases, solvents, disinfectants, pH adjusters, scents and dyes, buffers, viscosity regulators, corrosion inhibitors, complexing agents, film formers, further antimicrobial active ingredients, builders, bleaching agents, enzymes, organic and inorganic salts, optical brighteners, antioxidants, opacifiers, hydrotropes, abrasives, preservatives, oxidizing agents and insecticides and mixtures thereof.
